(19) United States
(12) Patent Application Publication
(10) Pub. No.: US 2015/0356093 A1
(43) Pub. Date: Dec. 10, 2015

(54) METHODS AND SYSTEMS RELATING TO RATINGS

(71) Applicant: MOHAMAD ABBAS, OTTAWA (CA)

(72) Inventor: MOHAMAD ABBAS, OTTAWA (CA)

(21) Appl. No.: 14/732,943

(22) Filed: Jun. 8, 2015

Related U.S. Application Data
(60) Provisional application No. 62/008,557, filed on Jun. 6, 2014.

(51) Int. Cl. G06F 17/30; G06F 3/0482; G06F 3/0488

(52) U.S. Cl. CPC G06F 17/30058; G06F 17/30876; G06F 3/0488; G06F 3/0482; G06F 17/30867

(57) ABSTRACT

As a result of a lack of meaningful generic rating methods and systems within the Internet most enterprises, political organizations, media providers, etc. maintain their use of the traditional prior art pre-Internet techniques for establishing user feedback. Accordingly, it would be beneficial to provide users with a means of rapidly and easily providing ratings on anything that they see, view, play, read, etc. across a wide range of websites, social media platforms, etc.

### CROSS-REFERENCE TO RELATED APPLICATIONS

This patent application claims the benefit of U.S. Provisional Patent Application U.S. 62/008,557 filed Jun. 6, 2014 entitled “Methods and Systems relating to Ratings”, the entire contents of which are included by reference.

### FIELD OF THE INVENTION

This invention relates to ratings and more particularly to methods and systems for obtaining, generating, and exploiting ratings by users.

### BACKGROUND OF THE INVENTION

Over the past decade the increasing power of microprocessors coupled with low cost electronic solutions, supporting cellular wireless services as well as personal and local area networks (PANs/LANs), low cost colour displays, social networks, and a range of different software applications have meant that access to information, content, and services has become ubiquitous. Today, users do not think about the technology behind their personal electronic devices and rather than considering them as running discrete software applications for specific functions they have become an integral part of their daily lives with overlapping features and element between multiple applications. Programs and applications to schedule activities, generate reminders, provide rapid communication capabilities, search, stream audiovisual content, and link users through social networks dominate today. The users access these programs and applications through a variety of graphical user interfaces (GUIs) allowing the users to interact through graphical icons and visual indicators such as secondary notation, as opposed to text-based interfaces, typed command labels or text navigation. GUIs were introduced in reaction to the perceived steep learning curve of command-line interfaces which require commands to be typed on the keyboard. User actions within a GUI are usually performed through direct manipulation/selection of the graphical elements and GUIs can be found in a range of electronic devices, both portable and fixed, including hand-held devices such as MP3 players, portable media players, gaming devices, household appliances, office, and industry equipment.

Such advances in combination with the advancements in network infrastructure mean that today a user may easily and rapidly access content from a wide range of sources with a wide range of reactions and /or views to what they access, read, view, hear, etc. In contrast the ability for advertiser, content providers, content generators, enterprises, and even individuals to gain insight into such reactions and/or views has not kept pace. Whilst traditional market research surveys, questionnaires, interviews, etc. are still employed these cannot react at the speed of information flow in today's world and hence may be thought of as giving longer term, filtered, or averaged feedback and/or rating information. Today, an item of content posted by a user, be it an individual or enterprise, can reach millions or tens of millions of individuals within a very short period of time, wherein the content today is said to have gone viral. But that same user may have viewed tens or hundreds of items of content that day and hence unless there is something particularly outstanding the user will not be able to provide meaningful rating and/or feedback information.

Upon the Internet that spawns and distributes such content the mechanisms are not much more effective. Within many websites users are able to add comments or provide reviews but typically unless the views/opinions of the user are particularly polarized they are unlikely to spend the time and energy adding their comments/views. Equally, given a website owner's ability to filter the content may are dubious as to the validity and/or representative nature of the comments/reviews. Users may be asked to give a rating, e.g. out of 10 or out of 5, and a product may accordingly be displayed with an averaged weighting of the users who rated it.

Within social media Facebook introduced the world to the “Like” feature which is described by Facebook™ as a way to “give positive feedback and connect with things you care about.” Accordingly, users can “like” status updates, comments, photographs, and links posted by their friends, as well as adverts, by clicking the “Like” button wherein the liked content then appears in their friends news feeds. The “Like” button is also available for use on websites outside Facebook™. In 2011 Google linked their “+1” button to Google Plus to create a rival feature. However, perhaps a user does not want to “Like” or “+1” something as they do not want the item being fed to their social network(s). Equally, a retailer seeking feedback on a particular product may establish a profile but the “Like” will be about the retailer generally unless they add pages for specific products/product ranges etc.

It is as a result of the lack of generic rating methods and systems within the Internet that most enterprises, political organizations, media providers, etc. maintain their use of the traditional prior art pre-Internet techniques. Accordingly, it would be beneficial to provide users with a means of rapidly and easily providing ratings on anything that they see, view, play, read, etc. across a wide range of websites, social media platforms, etc.

It would be beneficial to provide the rating system as a discrete application capturing user ratings for consolidation, social media posting, enterprise analytics etc.

It would also be beneficial to provide the ratings system as a transparent overlay to any application the user accesses allowing them to rapidly and easily provide ratings without having to perform a series of actions that distract from their primary basis of engaging with a website, web content, etc.

It would be further beneficial for the ratings system to have contextual awareness so that the ratings are associated to the context automatically.

It would be further beneficial for the ratings system to provide the user with a means of entering multiple ratings in a single activity.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations within the prior art relating to ratings and more particularly to methods and systems for obtaining, generating, and exploiting ratings by users.

In accordance with an embodiment of the invention there is provided a method of generating a rating for an item through a single swipe/touch interaction by a user with a haptic interface.

In accordance with an embodiment of the invention there is provided a method of generating a rating for an item through a single swipe/touch interaction by a user with a touchscreen interface.

In accordance with an embodiment of the invention there is provided a method of generating a rating for an item through the acquisition and processing of information generated by at least one of a wearable device, a camera, and an accelerometer.

In accordance with an embodiment of the invention there is provided a software application in execution upon an electronic device wherein the software application allows a user to enter a rating relating to content being viewed by the user associated with another software application in execution upon the electronic device.

In accordance with an embodiment of the invention there is provided a method of establishing a rating profile associated with a rating application and a user by user interactions with a software application in execution upon an electronic device, wherein the rating profile aggregates ratings made by the user independent of the electronic device, the content being rated, and an application used to present the content to the user.

In accordance with an embodiment of the invention there is provided a method of providing a rating feed to a user comprising aggregating ratings made by users in respect of content they have viewed independent of the electronic device, the content being rated, and an application used to present the content to the user.

In accordance with an embodiment of the invention there is provided a method of rating content and/or aggregating ratings associated with at least one of an item of content and a location wherein the aggregation of ratings associated with the location is performed independent of the electronic devices and applications exploited by the users to view the content.

In accordance with an embodiment of the invention there is provided a method of combining trending topics from a plurality of platforms upon which users generate ratings and/or hashtags.

In accordance with an embodiment of the invention there is provided a method of accessing content by searching at least one of ratings associated with content and/or hashtags associated with the content in dependence upon at least a filter.

In accordance with an embodiment of the invention there is provided a method of accessing advertisements for display to a user by searching at least one of ratings associated with content and/or hashtags associated with the content in dependence upon at least a filter.

In accordance with an embodiment of the invention there is provided a method of rating an item of content by applying a predetermined algorithm to a plurality of ratings, wherein each rating is associated with an aspect of the content.

In accordance with an embodiment of the invention there is provided a method of generating a rating for a live item of content through a single swipe/touch interaction by a user with a haptic interface.

In accordance with an embodiment of the invention there is provided a method of generating a plurality of ratings through a single continuous swipe/touch interaction by a user with a haptic interface.

In accordance with an embodiment of the invention there is provided a method of establishing a rating by requesting through a software application in execution upon an electronic device a plurality of user ratings, wherein the plurality of user ratings are crowd sourced.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network environment within which embodiments of the invention may be employed;

FIG. 2 depicts a wireless portable electronic device supporting communications to a network such as depicted in FIG. 1 and as supporting embodiments of the invention;

FIG. 3 depicts exemplary screenshots of a rating application according to an embodiment of the invention;

FIG. 4 depicts exemplary screenshots of a rating application according to an embodiment of the invention;

FIG. 5 depicts exemplary screenshots of a rating application according to an embodiment of the invention;

FIG. 6 depicts exemplary screenshots of a rating application according to an embodiment of the invention;

FIG. 7 depicts exemplary screenshots of a rating application according to an embodiment of the invention;

FIG. 8 depicts exemplary screenshots of a rating application according to an embodiment of the invention;

FIG. 9 depicts exemplary screenshots of a rating application according to an embodiment of the invention;

FIG. 10 depicts exemplary screenshots of a rating application according to an embodiment of the invention;

FIG. 11 depicts exemplary screenshots of a rating application according to an embodiment of the invention;

FIG. 12 depicts exemplary screenshots of a rating application according to an embodiment of the invention;

FIGS. 13 and 14 depict exemplary screenshots of a rating application according to an embodiment of the invention providing contextually based multiple rating entry;

FIGS. 15 and 16 depict exemplary screenshots of a rating application according to an embodiment of the invention displaying ratings during their generation;

FIG. 17 depicts exemplary screenshots and consolidation of ratings from an overlay rating application on multiple websites and the aggregation to the user's profile;

FIG. 18 depicts haptic gesture based rating interfaces for a rating application according to embodiments of the invention; and

FIG. 19 depicts an exemplary flowchart for a rating acquisition and posting process according to an embodiment of the invention.

### DETAILED DESCRIPTION

The present invention is directed to ratings and more particularly to methods and systems for obtaining, generating, and exploiting ratings by users.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and /or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™)

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals whose biometric data may be, but not limited to, monitored, acquired, stored, transmitted, processed and analysed either locally or remotely to the user wherein by their engagement with a service provider, third party provider, enterprise, social network, social media etc. via a dashboard, web service, website, software plug-in, software application, graphical user interface acquires, for example, electronic content. This includes, but is not limited to, private individuals, employees of organizations and/or enterprises, members of community organizations, members of charity organizations, men, women, children, teenagers, and animals. In its broadest sense the user may further include, but not be limited to, software systems, mechanical systems, robotic systems, android systems, etc. that may be characterised by data relating to a subset of conditions including, but not limited to, their environment, medical condition, condition, biological condition, physiological condition, chemical condition, ambient environment condition, position condition, neurological condition, drug condition, and one or more specific aspects of one or more of these said conditions.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Quantified self” as used herein may refer to, but is not limited to, the acquisition and storage of data relating to a user's daily life in terms of inputs (e.g. food consumed, quality of surrounding air), states (e.g. mood, arousal, blood oxygen levels), and performance (mental and physical). Acquisition of data may be combine wearable sensors (EEG, ECG, video, etc.) and wearable computing together with audio, visual, audiovisual and text based content generated by the user.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, heart rate, temperate, altitude, vibration, motion, perspiration, EEG, ECG, energy level, etc. In addition biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

Reference to “content information” as used herein may refer to, but is not limited to, any combination of content features, content serving constraints, information derivable from content features or content serving constraints (referred to as “content derived information”), and/or information related to the content (referred to as “content related information”), as well as an extension of such information (e.g., information derived from content related information).

Reference to a “hashtag” or “#tag” as used herein may refer to, but is not limited to, any word or unspaced phrase prefixed with the number sign (“#”). It is a form of metadata tag wherein words in messages on a variety of services including, but not limited to, microblogging and social networking services such as Twitter, Facebook, Google+ and Instagram, for example, may be tagged by putting “#” before them, either as they appear in a sentence or appended to it. Hashtags allow functions to be performed based upon them such as grouping, filtering, sorting, etc. such messages as applications can search for the hashtag(s) and get the set of messages that contain it or them. A hashtag is today only connected to a specific medium but embodiments of the invention are not limited as such and allow hashtags to be linked and connected to pictures, videos, multimedia content, messages, documents, and electronic content across a range of software applications.

Reference to a “document” as used herein may refer to, but is not limited to, any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.). In the context of the Internet, a common document is a Web page. Web pages often include content and may include embedded information (such as meta-information, hyperlinks, etc.) and/or embedded instructions (such as Javascript, etc.). In many cases, a document has a unique, addressable, storage location and can therefore be uniquely identified by this addressable location such as a universal resource locator (URL) for example used as a unique address used to access information on the Internet.

“Document information” as used herein may refer to, but is not limited to, may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

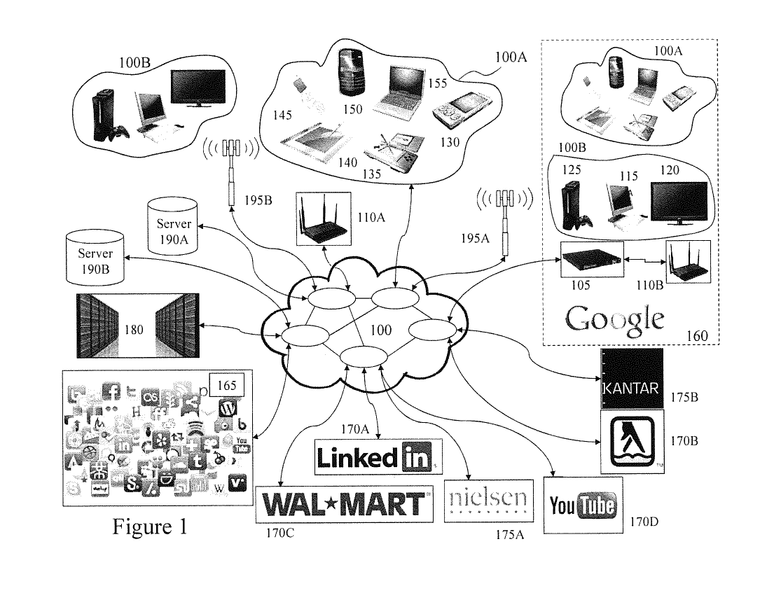

Referring to FIG. 1 there is depicted a network environment 100 within which embodiments of the invention may be employed supporting rating systems and rating applications/platforms (RSRAPs) (RSRAPs) according to embodiments of the invention. Such RSRAPs, for example supporting multiple channels and dynamic content. As shown first and second user groups 100A and 100B respectively interface to a telecommunications network 100. Within the representative telecommunication architecture a remote central exchange 180 communicates with the remainder of a telecommunication service providers network via the network 100 which may include for example long-haul OC-48/OC-192 backbone elements, an OC-48 wide area network (WAN), a Passive Optical Network, and a Wireless Link. The central exchange 180 is connected via the network 100 to local, regional, and international exchanges (not shown for clarity) and therein through network 100 to first and second cellular APs 195A and 195B respectively which provide Wi-Fi cells for first and second user groups 100A and 100B respectively. Also connected to the network 100 are first and second Wi-Fi nodes 110A and 110B, the latter of which being coupled to network 100 via router 105. Second Wi-Fi node 110B is associated with Enterprise 160, e.g. Google™, within which other first and second user groups 100A and 100B respectively are present. Second user group 100B may also be connected to the network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 110A the first group of users 100A may employ a variety of PEDs including for example, laptop computer 155, portable gaming console 135, tablet computer 140, smartphone 150, cellular telephone 145 as well as portable multimedia player 130. Within the cell associated with second AP 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular AP 195B provides coverage in the exemplary embodiment to first and second user groups 100A and 100B. Alternatively the first and second user groups 100A and 100B may be geographically disparate and access the network 100 through multiple APs, not shown for clarity, distributed geographically by the network operator or operators. First cellular AP 195A as show provides coverage to first user group 100A and environment 170, which comprises second user group 100B as well as first user group 100A. Accordingly, the first and second user groups 100A and 100B may according to their particular communications interfaces communicate to the network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly portable electronic devices within first user group 100A may form associations either through standards such as IEEE 802.15 and Bluetooth as well in an ad-hoc manner.

Also connected to the network 100 are Social Networks (SOCNETS) 165, first and second business information resources 170A and 170B respectively, e.g. LinkedIn™ and Yellow Pages™, retailer website 170C, e.g. WalMart™, entertainment website 170D, e.g. YouTube™, and first to second market research entities 175A and 175B respectively, e.g. The Nielsen Company™ and Kantar™, as well as first and second servers 190A and 190B together with others, not shown for clarity. First and second servers 190A and 190B may host according to embodiments of the inventions multiple services associated with a provider of rating systems and rating applications/platforms (RSRAPs); a provider of a SOCNET or Social Media (SOME) exploiting RSRAP features; a provider of a SOCNET and/or SOME not exploiting RSRAP features; a provider of services to PEDS and/or FEDS; a provider of one or more aspects of wired and/or wireless communications; an Enterprise 160 exploiting RSRAP features; license databases; content databases; image databases; content libraries; customer databases; websites; and software applications for download to or access by FEDs and/or PEDs exploiting and/or hosting RSRAP features. First and second primary content servers 190A and 190B may also host for example other Internet services such as a search engine, financial services, third party applications and other Internet based services.

Accordingly, a consumer and/or customer (CONCUS) may exploit a PED and/or FED within an Enterprise 160, for example, and access one of the first or second primary content servers 190A and 190B respectively to perform an operation such as accessing/downloading an application which provides RSRAP features according to embodiments of the invention; execute an application already installed providing RSRAP features; execute a web based application providing RSRAP features; or access content. Similarly, a CONCUS may undertake such actions or others exploiting embodiments of the invention exploiting a PED or FED within first and second user groups 100A and 100B respectively via one of first and second cellular APs 195A and 195B respectively and first Wi-Fi nodes 110A.

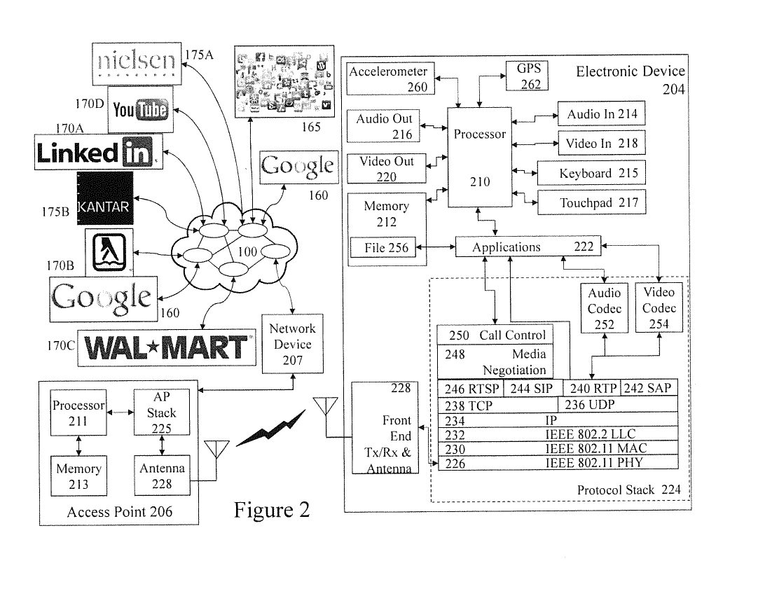

Now referring to FIG. 2 there is depicted an electronic device 204 and network access point 207 supporting RSRAP features according to embodiments of the invention. Electronic device 204 may, for example, be a PED and/or FED and may include additional elements above and beyond those described and depicted. Also depicted within the electronic device 204 is the protocol architecture as part of a simplified functional diagram of a system 200 that includes an electronic device 204, such as a smartphone 155, an access point (AP) 206, such as first AP 110, and one or more network devices 207, such as communication servers, streaming media servers, and routers for example such as first and second servers 190A and 190B respectively. Network devices 207 may be coupled to AP 206 via any combination of networks, wired, wireless and/or optical communication links such as discussed above in respect of FIG. 1 as well as directly as indicated. Network devices 207 are coupled to network 100 and therein SOCNETS 165, first and second business information resources 170A and 170B respectively, e.g. LinkedIn™ and Yellow Pages™, retailer website 170C, e.g. WalMart™, entertainment website 170D, e.g. YouTube™, and first to second market research entities 175A and 175B respectively, e.g. The Nielsen Company™ and Kantar™, Enterprise 160, e.g. Google™, as well as first and second servers 190A and 190B together with others, not shown for clarity.

The electronic device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 204 may include an audio input element 214, for example a microphone, and an audio output element 216, for example, a speaker, coupled to any of processors 210. Electronic device 204 may include a video input element 218, for example, a video camera or camera, and a video output element 220, for example an LCD display, coupled to any of processors 210. Electronic device 204 also includes a keyboard 215 and touchpad 217 which may for example be a physical keyboard and touchpad allowing the user to enter content or select functions within one of more applications 222. Alternatively the keyboard 215 and touchpad 217 may be predetermined regions of a touch sensitive element forming part of the display within the electronic device 204. The one or more applications 222 that are typically stored in memory 212 and are executable by any combination of processors 210. Electronic device 204 also includes accelerometer 260 providing three-dimensional motion input to the process 210 and GPS 262 which provides geographical location information to processor 210.

Electronic device 204 includes a protocol stack 224 and AP 206 includes a communication stack 225. Within system 200 protocol stack 224 is shown as IEEE 802.11 protocol stack but alternatively may exploit other protocol stacks such as an Internet Engineering Task Force (IETF) multimedia protocol stack for example. Likewise AP stack 225 exploits a protocol stack but is not expanded for clarity. Elements of protocol stack 224 and AP stack 225 may be implemented in any combination of software, firmware and/or hardware. Protocol stack 224 includes an IEEE 802.11-compatible PHY module 226 that is coupled to one or more Front-End Tx/Rx & Antenna 228, an IEEE 802.11-compatible MAC module 230 coupled to an IEEE 802.2-compatible LLC module 232. Protocol stack 224 includes a network layer IP module 234, a transport layer User Datagram Protocol (UDP) module 236 and a transport layer Transmission Control Protocol (TCP) module 238.

Protocol stack 224 also includes a session layer Real Time Transport Protocol (RTP) module 240, a Session Announcement Protocol (SAP) module 242, a Session Initiation Protocol (SIP) module 244 and a Real Time Streaming Protocol (RTSP) module 246. Protocol stack 224 includes a presentation layer media negotiation module 248, a call control module 250, one or more audio codecs 252 and one or more video codecs 254. Applications 222 may be able to create maintain and/or terminate communication sessions with any of devices 207 by way of AP 206. Typically, applications 222 may activate any of the SAP, SIP, RTSP, media negotiation and call control modules for that purpose. Typically, information may propagate from the SAP, SIP, RTSP, media negotiation and call control modules to PHY module 226 through TCP module 238, IP module 234, LLC module 232 and MAC module 230.

It would be apparent to one skilled in the art that elements of the electronic device 204 may also be implemented within the AP 206 including but not limited to one or more elements of the protocol stack 224, including for example an IEEE 802.11-compatible PHY module, an IEEE 802.11-compatible MAC module, and an IEEE 802.2-compatible LLC module 232. The AP 206 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

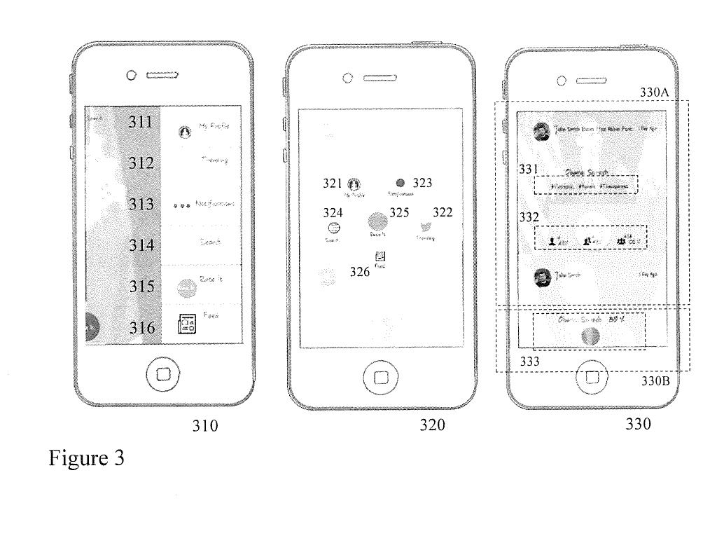

FIG. 3 there are depicted first to third screenshots 310 to 330 respectively of a RSRAP according to an embodiment of the invention. First screen shot 310 depicts a navigation bar for the RSRAP which may, for example, be brought into view by the user making a swiping motion to the left bring the navigation bar into view allowing the user to access or navigate areas of the RSRAP including, as depicted, their profile 311, trending topics 312, notifications 313, perform a search 314, rate 315 an item, and view a feed 316. Alternatively, as depicted in second screenshot 320 the user accesses the RSRAP through a different touchscreen function, e.g. a double tap, wherein a menu is displayed atop their display over all applications, UIs, etc. currently displayed to the user. The display now provides navigation to these areas via overlay buttons 321 to 326 respectively. Within third screenshot 330 the user is presented with rating information together with feed information relating to a speech made by President Obama which the user has accessed previously and rated. Accordingly, the RSRAP displays that a friend “John Smith” rated a post made by the user “Moe Abbas” 1 day ago. Also depicted within hashtag zone 331 are the hashtags #Patriotic, #Honest, and #Transparent which were applied by the user when they rated the speech. Within rating field 332 the user is presented with three ratings, which from left to right respectively are:
The average rating of the user for the topic/content as they may have viewed/accessed the content over a period of time, optionally, if the user selects this rating icon then they are presented with data relating to the multiple instances such as date/time and specific rating given;
The average rating of their friends, which may for example be across a social network they are currently logged into, a social network they have associated to the RSRAP, or a plurality of social networks the user has associated to the RSRAP; and
The average rating of all users, which may for example be all users across a social network they are currently logged into, across a social network they have associated to the RSRAP, or a plurality of social networks the user has associated to the RSRAP.

Alternatively, the user may elect to select rate icon 333 wherein they make a rating in a manner such as described below in respect of embodiments of the invention such that they may swipe such that the longer the swipe the higher the rating, the longer they maintain contact with the touchscreen the rating increases, decreases, cycles, etc. Accordingly, through first and second screenshots 310 and 320 respectively, the user may navigate to all areas of the RSRAP. Within embodiments of the invention the RSRAP may provide varying functionality according to the specific RSRAP loaded, according to the context of the content/device/user/etc. at that point in time, or according to a subscription level of the user with the RSRAP. For example, within a SOCNET the RSRAP may provide full feature availability whereas within a content based website, e.g. SoundCloud™ or YouTube™, then a more restricted feature set may be provided.

Accordingly, a user may within second screenshot 320 whilst viewing a speech made by President Obama have selected to open the RSRAP application and selected one, two, or three icons for example before pausing which the RSRAP takes as commands to perform actions associated with the one, two, or three icons selected. In doing so, the RSRAP transitions to third screenshot 330 where the user selected feed 326 and rate 325 wherein these expanded down to provide first and second regions 330A and 330B respectively. If the user selects a rater within the feed then the RSRAP may transition to display a predetermined number of posts of the rater and provide the user with the ability to follow the rater. With the rate icon 333 within second region 330B the user may rate a highlighted post from the rate it icon using a rating generation technique such as described below in respect of embodiments of the invention. Based upon the user rating a post then this may be pushed to one or more locations, including, but not limited to, one or more of the raters profile, the raters SOCNET, the post generator's SOCNET, and the post generator's profile. Optionally, a filter may be applied to prevent flooding of low value ratings or to limit the number of ratings from a specific user. Optionally, the user may select one or more criteria determining when a feed may be displayed.

Within an embodiment of the invention the user rates by starting from the rate icon and swiping away wherein as they swipe the percentage rating is shown. To lock the rating the user releases and taps the icon again. If they release and return to swiping the rating continues to be modified. To cancel the user taps anywhere else on the screen. Ratings can be adjusted by moving the tip of the rating back down or up according to the desired modification. Optionally, if the user releases and then swipes again towards the rate icon 333 then the rating may be reduced whilst moving their finger further away from the rate icon 333 increases the rating. Optionally, the rating may start at 0% or 100% or a predetermined value, such as the rating previously given by the user for the item being rated.

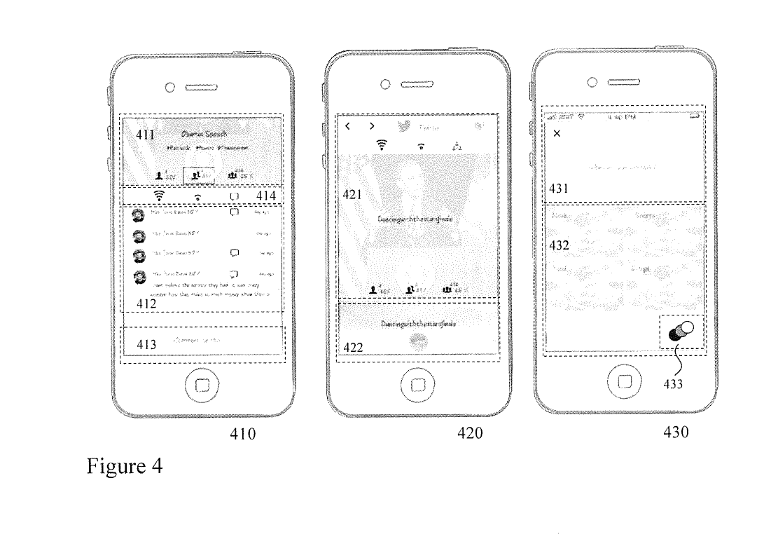

Now referring to FIG. 4 there are depicted first to third screenshots 410 to 430 respectively of a RSRAP according to an embodiment of the invention. Accordingly, in first screenshot 410 the user has selected their friend's rating icon in the rating field 332 depicted in third screenshot 330 in FIG. 3 whereby the screen transitions to first screenshot 410 in FIG. 4 wherein they are presented with reduced context pane 411 that includes in background an image of the item to which ratings are applicable and the ratings of themselves, their friends, and all users. The friends rating icon is highlighted as this was the one selected by the user and below this are feed field 412, comment field 413, and filter feed 414 displayed to the user as a result. The filter feed 414 contains icons from left to right for highest rated, lowest rated, and displaying all comments. Initially feed field 412 and comment field 413 may be hidden pending selection by the user of a filter within filter feed 414 at which point the context pane 411 is pushed to become a screen header as users scroll down. When the user returns to the top then the context pane 411 reopens to display second screenshot 420 in FIG. 4. Initially, the filter feed 412 displays summary data but the user can select individual comments to expand. Any comment that the user has selected can then be immediately commented upon by the user through the comment field 413. Optionally, the comment field 413 is displayed to one side of the screen together with rate icon allowing the user to immediately rate the selected comment.

Second screenshot 420 provides the user with re-expanded content in first field 421 and rating icon 422 for providing a rating. Now referring to third screenshot 430 in FIG. 4 the user is presented with a search screen such as may be displayed upon their selection of a search icon/button within a navigation window of an RSRAP. Accordingly, the user may select search field 431 or they can navigate to discover recently menus within menu field 432 wherein the categories may be automatically established by the RSRAP based upon the users searching history, pre-populated by the RSRAP or selected by the user. Selection of one of the menu items within menu field, e.g. news, food, sport, design, results in the screen transitioning to a screen depicting in one embodiment of the invention their last searches in these categories wherein the user can select a search and be displayed the results for that search. Alternatively, the results displayed within the screen as a result of selecting a category are the items rated by the user within that category with the highest ratings. In either instance selection of rating button 433 allows the user to adjust the filtering applied such that, for example, the search results are filtered based upon their individual ratings, the ratings applied by their friends within one or more SOCNETs, or the ratings applied by all users.

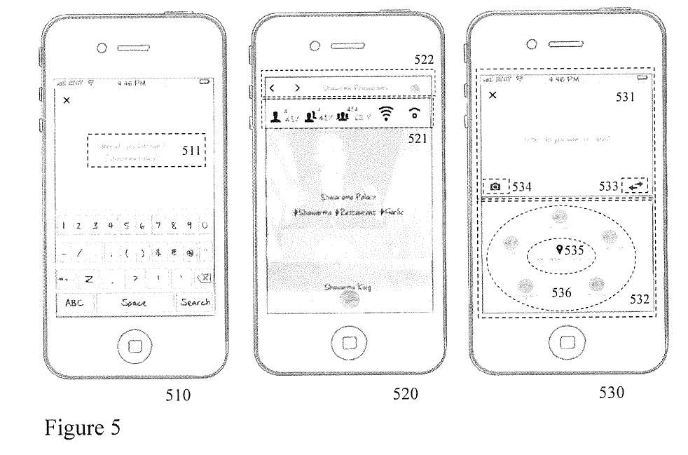

If the user selects to search through search field 431 they are presented with search screen as depicted in first screenshot 510 in FIG. 5 wherein the user is presented with a keypad to type their search query. Optionally, a suggestion is presented to the user in option field 511. This may, for example, be the latest item rated by a friend within their SOCNET(s), a highest/latest trending topic within a selected feed of the user, e.g. SOCNET feed, RSS feed, etc. When the user enters a search term then the screen transitions to a search result such as those known within the prior art but now with filter bar 521 and header 522. Accordingly, the user may select an item within the search results either unfiltered or by applying ratings filter based upon their personal ratings, their SOCNET friend ratings, and all user ratings. Through the navigation features the user may scroll up/down through search results or may elect to open an item and then navigate forward/backward through other searches using the back/forward buttons within the header 522.

If the user has selected rate 315 or rate 325 in first and second screenshots 310 and 320 respectively in FIG. 3 then they are presented with third screenshot 530 representing a “Rate It” feature of an RSRAP according to an embodiment of the invention. As depicted the third screenshot 530 comprises upper field 531 and lower field 532. In the upper field the user may select something they wish to rate, e.g. through tapping the screen, entering a keyword/keyword etc. and being presented with a list of results from which they select an item. They are then returned to third screenshot 530 wherein this item selected is displayed in upper field 531 wherein the user may add a rating such as through an embodiment of the invention described below. The user may through forward/backward arrows 533 transition to search results up/down from the initial one selected and through camera icon 534 select an image to add to their rating which may for example be a profile picture, an item from the content they are reviewing, or a visual indication of their rating (e.g. a tick, a cross, a thumbs up, thumbs down, etc.).

Within the lower field 532 the user is presented with a set of topics to rate which are established by initial preferences established within the RSRAP or as modified by the user subsequently. In this instance the default central topic 535, may be determined from the user's geolocation information, e.g. Starbucks Coffee Co., whilst other topics in ring 536 may be established based upon filters associated with the user by the RSRAP through adaptive learning of the user's preferences, friends, SOCNETs, work, hobbies, searches, etc. Accordingly, the user may tap one of the displayed topics and add their own rating. For the items within the ring 536 these are displayed with ratings based upon all users, for example. Optionally, the ring 536 may be a set of topics relating to the central topic 535 such that, for example, Starbucks Coffee Co. wishes to ascertain market research information and engages RSRAP to have the ring 536 display speed of service, range of products, coffee, cost, and friendliness of servers. As the RSRAP knows when the geolocation maps to a Starbucks Coffee Co. location when populating central topic 535 it may acquire the topics in the ring 536 dynamically from a remote server and the user's rating(s) are not only employed in establishing new rating(s) but are now accessible through the RSRAP together with other information, e.g. demographics, time/date, etc. as well as allowing these user rating(s) to be merged/assessed against others of that user, their demographic, and the population overall.

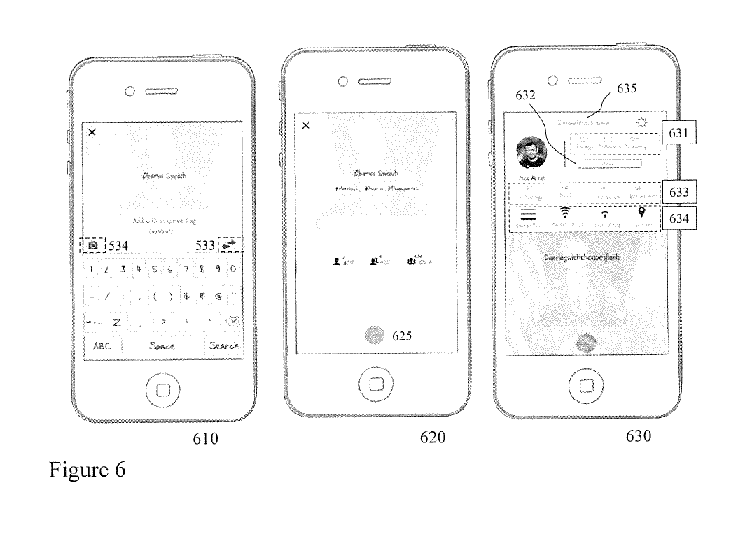

Now referring to FIG. 6 there are depicted first to third screenshots 610 to 630 respectively of a RSRAP according to an embodiment of the invention. Within first screenshot 610 a user wishes to add one or more hashtags in association with an item of content, document, post, feed etc. Accordingly, the user may perform a predetermined action which is assessed by the RSRAP as hashtag entry, e.g. sequential taps at left and right sides of touchscreen, wherein the display according to first dashboard 610 is presented where a keypad is presented for entering the one or more hashtags together with arrows 533 allowing the user to transition forward/backward to search results up/down from the initial one selected and through camera icon 534 select an image to add to their rating which may for example be a profile picture, an item from the content they are reviewing, or a visual indication of their rating (e.g. a tick, a cross, a thumbs up, thumbs down, etc.).

The user may search through a keypad feature entitled “Search” which may, example, list the top hashtags associated with item being rated by the user or the subject of the item being rated. Accordingly, for rating a speech by President Obama the search feature may list the top 10 hashtags for that speech and/or the top 10 hashtags for President Obama personally rather than the speech per se. Upon completion the user is presented with second screenshot 620 where the hashtags the user has associated to the item are displayed together with rating results and the rate it icon 625. Optionally, at this point the user may be presented with options to comment upon the feed/content in addition to a rating.

Referring to third screenshot 630 in FIG. 6 the user is presented with a profile of another user wherein the third screenshot 630 displays the name of the other user 635, SOCNET data 631 including how many ratings, number of followers, and the number of users the other user is following. They are also presented with Follow button 632, analysis bar 633, and rating bar 634. Within analysis bar 633 the user can see the distribution of ratings made by the user within particular topic fields, e.g. technology, food, restaurants, sports, social, etc. Accordingly, the user may make a subjective assessment of the other user's comment on a restaurant, for example, which is different if the user has posted 34 ratings for restaurants then they have post 3 or 133, for example. Within rating bar 634 the user may filter based upon only ratings, highest ratings, lowest ratings, and geolocations for example although other filters may be established by the RSRAP and/or user.

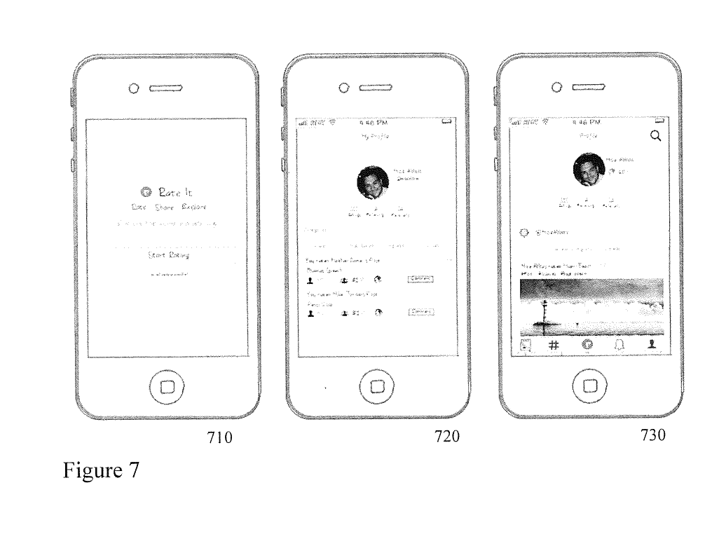

Now referring to FIG. 7 there are depicted first to third screenshots 710 to 730 respectively of a RSRAP according to an embodiment of the invention, wherein the first screenshot 710 depicts a splash screen for the RSRAP at user initiation with a field “Start Rating” to allow a new user to register and “I'm Already a Member” to allow a registered user to login. Second screenshot 720 depicts a user's profile page with their photograph, user data such as number of ratings the user has given, the number of people the user is following, and the number of followers for the user whist the screen also displays the last 2 ratings made by the user together with their rating, their friends average rating, and all user average rating for that item rated. The user may also enter a comment through the associated comment button next to each and may scroll through their ratings using standard touchscreen motions wherein the rating activities displayed are selected by a filter such as newest, most rated, highest, and lowest in rating filter selector bar. Third screenshot 730 depicts another user's profile page with their photograph, user data such as number of ratings that user has given, the number of people that user is following, and the number of followers following that user whist the screen also displays the last ratings made by the user together with the rating they gave, hashtags the user associated with the content they rated. The user can elect to follow the other user through the “Follow” button and navigate within the RSRAP in bottom toolbar comprising rating feed, trending, rate it, notifications, and my profile.

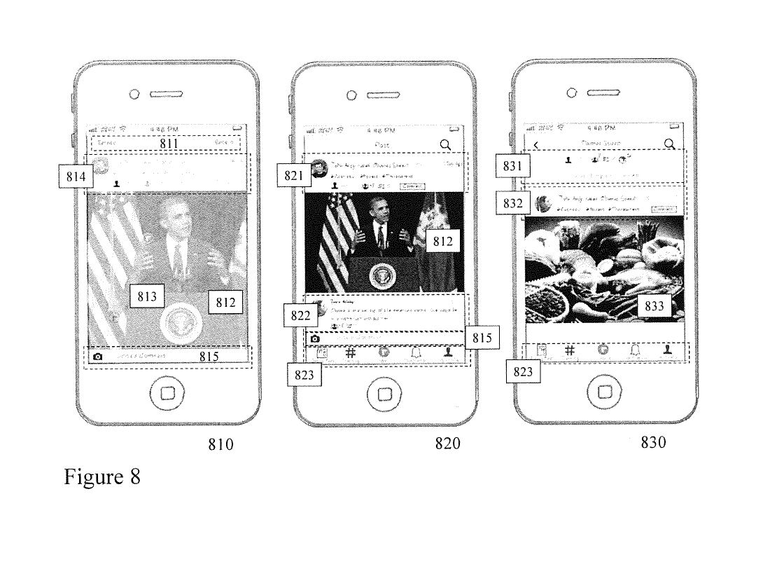

Referring to FIG. 8 there are depicted first to third screenshots 810 to 830 respectively of a RSRAP according to an embodiment of the invention. Within first screenshot 810 the user is presented with:
RateIt/Rerate option bar 811 wherein, for example, on an initial rating the user may attach hashtags and assign a rating and then subsequently can only add other ratings which do not replace their original rating such that a user's historical rating of an item can be tracked, monitored, displayed etc.;
Content 812 which the user has accessed to view/rate;
Rating swipe 813 indicating a motion according to an embodiment of the invention of the user rating the content 812, where in this instance the motion is depicted during execution;
Review bar 814 wherein the user's name, profile image etc. are depicted together with the title of the content they rates, the hashtags they associated with the content, their rating (averaged if multiple), their friends averaged rating, and the averaged rating of all users plus any comment they have added; and
Comment field 815 where the user has the ability to add a comment.

Second screenshot 820 displays the post made by the user to the user subsequently so that the user can view:
Feed 821, which displays who has read their pot and when;
Content 812;
Posts 822, made by others in respect of the content 812 the user rated;
Comment field 815 where the user has the ability to add a comment; and
Navigation bar 823 for navigating within the RSRAP, such as comprising rating feed, trending, rate it, notifications, and my profile.

Third screenshot 830 displays the post made by another user selected by the user, e.g. the post displayed within Posts 822, wherein the user can view:
Feed ratings 831;
Other user feed 832 including the hashtags associated by the other user and the other user's rating, comment etc.;
Image 833, associated by the other user to the Content 812;
Posts 822, made by others in respect of the content 812 the user rated; and
Navigation bar 823 for navigating within the RSRAP, such as comprising rating feed, trending, rate it, notifications, and my profile.

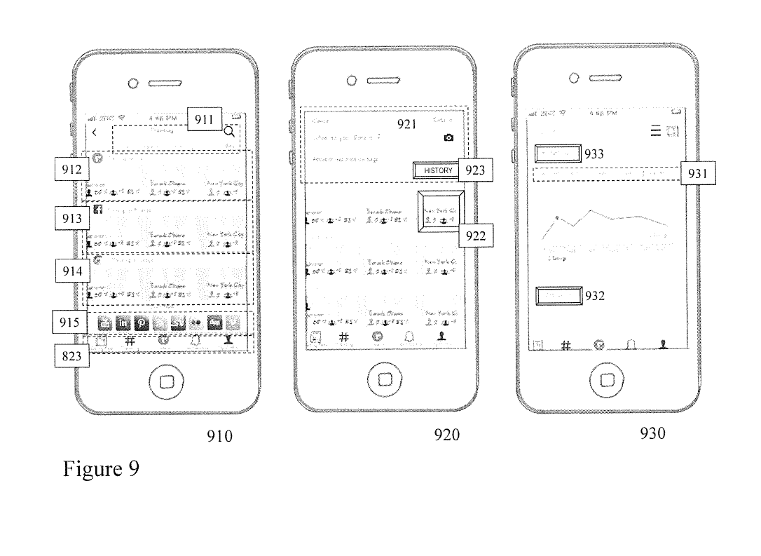

Referring to FIG. 9 there are depicted first to third screenshots 910 to 930 respectively of a RSRAP according to an embodiment of the invention. In first screenshot 910 the user has navigated to a trending area of the RSRAP and is presented with:
Configuration bar 911 that defines filters for the trending screen, such as most popular, highest rated, lowest rated, etc. and means for the user to edit the displayed options;
First to third SOCNET feeds 912 to 914 respectively which depict feeds within each SOCNET after the filtering established in configuration bar 911 is applied wherein the SOCNETs may, for example, be those associated to the RSRAP by the user as they have accounts or SOCNETs/websites etc. that the user wishes to monitor;
Feed changer bar 915 wherein the user may tap and drag, for example, a different network into any of the first to third SOCNET feeds 912 to 914 respectively to view a different SOCNET/website/RSS feed, blog etc. that is of interest wherein options within the feed changer bar 915 may be established by the user linking sources to the RSRAP; and
Navigation bar 823.

If the user selects an item within one of the first to third SOCNET feeds 912 to 914 respectively then this is highlighted as topic 922 in second screenshot 920 in FIG. 9 and rating field 921 is presented allowing the user to rate the item through a gesture such as described within embodiments of the invention, attach hashtags to the rating the user generates, attach an image, etc. and select a history button 923. Selection of the history button 923 triggers third screenshot 930 which displays to the user graphically the ratings they have given based upon a time range selected within time bar 931. Optionally, the user may select one or more categories to filter the ratings with category icon 932 or select a filter for ratings through rating button 933. Optionally, where the user scrolls the marker across the graphical display then the top ratings may be displayed within the third screenshot 930 as well. Optionally, the graphical display may be scrolled, expanded, compressed etc. through actions of the user through the buttons on the time bar 931 or through their interaction with the touchscreen of the PED upon which they are accessing the RSRAP.

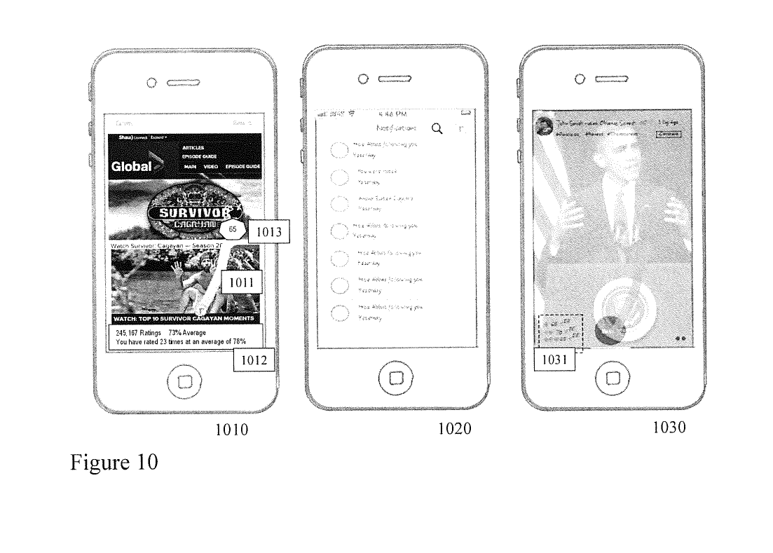

Now referring to FIG. 10 there are depicted first to third screenshots 1010 to 1030 respectively of a RSRAP according to an embodiment of the invention. Within first screenshot 1010 the user is rating an item of content using an RSRAP that acts as an overlay application to others that the user executes upon their PED and/or FED for example. Accordingly, the user has accessed a portion of a website, associated with a television network Global, relating to a television show, Survivor, and is making a rating having initiated this through the RSRAP by making the initial action to trigger generating a rating and then moving their finger to generate the rating via swipe 1011 which includes current rating marker 1013 so that the user can view the actual level they are setting. Optionally, the rating marker 1013 may be displayed to the user as an indicator at a predetermined location of the screen or as described below be based upon selection of one of a range of marker/rating options by the user. They are also presented with rating overview field 1012 that shows the number of ratings made overall, the average rating to date, the number of times the user has rated the topic, and their average rating.

Referring to second screenshot 1020 this would be depicted to the user in the event that they have selected the notifications feature within a navigation menu such as depicted in first and second screenshots 310 and 320 in FIG. 3. Accordingly, they are presented with a scrollable list of notifications such as someone starting to follow them, someone rated the user, or another user within one or more of their friend groupings upon one or more SOCNETs made a rating. Optionally, the user may be presented with a series of filters such as setting thresholds for ratings that they wish to have filtered out, friend list filters etc. as well as the RSRAP combining other user actions together such that rather than receiving 10 notifications that “Anna rated XX”, etc. they are given a single notification that “Anna made 10 ratings . . . click to see the topics” such that selecting the single notification provides a list of the topics that Anna rated so that the user can decide whether to view any or not.

Referring to third screenshot 1030 the user is presented as being mid-rating for adding their rating to one already provided by “John Smith” in respect of a speech by President Obama. Also depicted upon the screen are star ratings 1031 wherein user who reach a certain level of ratings or a certain level of rating consistency are given star profiles within the RSRAP. For example, a user who consistently rates at a value that reflects the median/mean/average of their SOCNET friend grouping may be considered to be a 2 star user whereas a user who regularly rates 30 or more items per day is a lower rating at 1 star user. A three star user may a combination thereof in that not only do they rate frequently but their ratings are also representative of a large grouping of users.

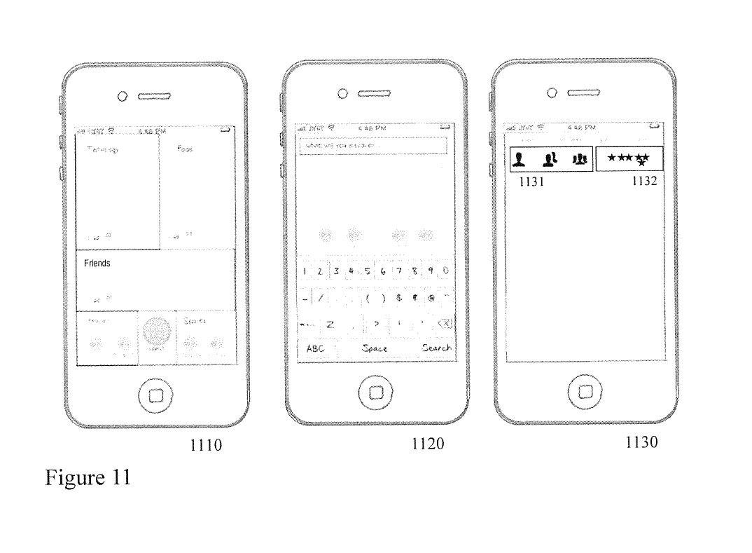

Now referring to FIG. 11 there are depicted first to third screenshots 1110 to 1130 respectively of a RSRAP according to an embodiment of the invention. Within first screenshot 1110 the user is presented with a display similar to third screenshot 430 in FIG. 4 where the user was presented with a search screen but now the user is presented with items that are trending within the areas of interest of the user, e.g. technology, food, movies, sports, and friends based upon filters the user has set in terms of rating thresholds, users, star users, etc. Alternatively if they see nothing there of interest that they wish to rate or comment upon or the topic is not present then they may select the search wherein they are transitioned to second screenshot 1120 wherein they may enter a search term or terms. They are also presented with a predetermined number, e.g. 4, of the highest rated topics within their areas of interest in case this overlooked or they change their mind. Once they have entered the search terms in second screenshot 1120 they are presented with search results within third screenshot 1130 wherein these are results from a standard search engine, e.g. Bing™, Google™, etc. but are now also denoted and/or ranked by the ratings of either the user themselves, their friends, all users and/or the star ratings of users. Accordingly, if the user is searching a restaurant in San Francisco they may elect to seek those rate 70% or higher by users with 3 star rating as these would therefore be positive reviews by users who represent a consistent viewpoint of a large number of other users which is substantially different rating to the average of all users.

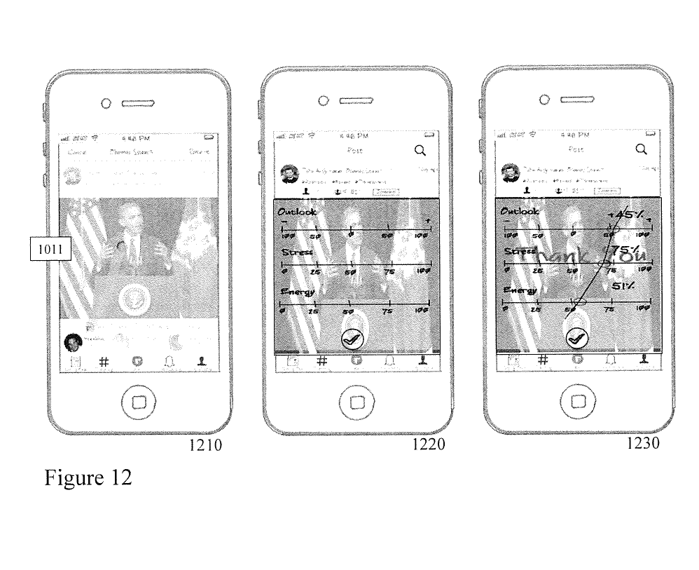

Now referring to FIG. 12 there are depicted first to third screenshots 1210 to 1230 respectively of a RSRAP according to an embodiment of the invention. Within first screenshot the user is depicted viewing an item of content and making a rating through a swiping action according to an embodiment of the invention. Also depicted are other rating data as well as navigation data. However, it would be evident that a RSRAP according to an embodiment of the invention either operating as an application per se or as a transparent overlay is only capturing a single item of rating data which is presumed in the instance depicted to be the user's rating of President Obama. However, if the user rates low is that a reflection of President Obama himself or rather a rating determined by the subject of his speech, e.g. increasing taxation. Accordingly, it would be beneficial in some instances for the user to be able to rate multiple elements simultaneously such as depicted in second and third screenshots 1220 and 1230 respectively. In second screenshot 1220 the user is presented with three rating bars which are entitled outlook, stress and energy in respect of President Obama wherein the user may then in a single continuous swipe as depicted in third screenshot 1330 enter ratings for each of these such that outlook is 45%, stress is 75%, and energy 51%. These three topics were established by the RSRAP in respect of the content being viewed by the viewer as these had been set by CNN™ which was the website that the content was being viewed from. Alternatively, the topics for user ratings may have been set by one or more other parties seeking feedback on President Obama in more detail than a single overall approval rate. Hence, an alternative topic set might have been Approval Rating of Obama, Taxation Approval, and State of the Nation.

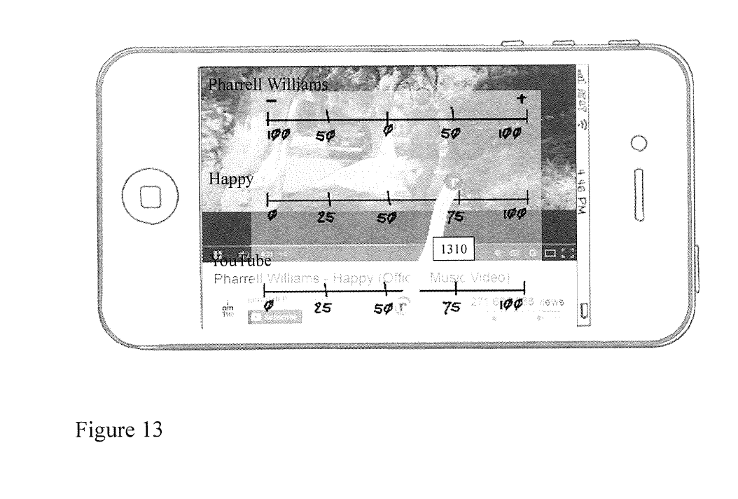

Similarly, in FIG. 13 there is depicted an exemplary screenshot of a RSRAP according to an embodiment of the invention providing contextually based multiple rating entry. In this instance the user is watching a video upon YouTube™ of the song “Happy” by Pharrell Williams wherein the rating screen when activated by the user now displays ratings for Pharrel Williams, the song “Happy”, and for YouTube™. As indicated by swipe 1310 the user has currently completed ratings for YouTube™ and “Happy” but has yet to complete the swipe for Pharrell Williams. In some instances despite being presented with multiple options the user may elect to only rate one item. It would be evident that the number of ratings within a multiple rating screen may be varied in portrait and landscape orientations as well as being varied based upon user preferences and/or topics associated with the content by the content provider, content originator, advertiser, etc.

Optionally, the multiple ratings established are all associated with characteristics of an item of content but not the item of content itself. For example, the multiple ratings might be “foreign policy”, “women's rights” and “economics” in respect of a speech given by President Obama. However, instead of rating President Obama directly the three ratings, for example R_{FOREIGN}, R_{WOMEN}, and R_{ECONOMICS}, are combined through an algorithm such that for example, Equation (1) applies.

R_{OBAMA}=ℑ₁(R_{FOREIGN})+ℑ₂(R_{WOMEN})+ℑ₃(R_{ECONOMICS}) (1)

Similarly, in FIG. 13 there is depicted an exemplary screenshot of a RSRAP according to an embodiment of the invention providing contextually based multiple rating entry. Accordingly, a user is detected as being within a Starbucks™ due to the association of their PED with the WiFi transceiver within the retail outlet. Accordingly, the user is presented with a multiple ratings including, for example:
How did you rate the service today?
Were the barista's friendly?
How do you rate Bridgehead?
How do you rate Roast'n Brew?
Do our seasonal drinks appeal?

Whilst all the ratings are depicted as being scores from 0-100 it would be evident to one skilled in the art that other rating scales may be employed including, for example, [0,1, . . . , 9,10}; {A,B, . . . , F,G}; {Awful, Bad, Poor, Good, Very Good, Exceptional}, etc.

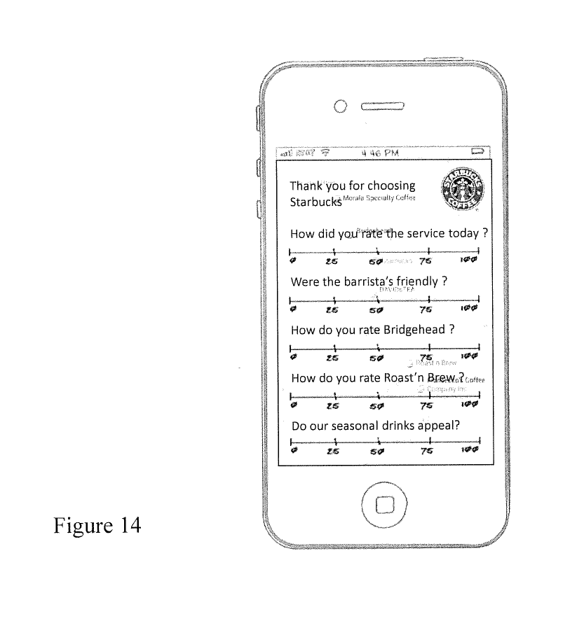

Accordingly, as depicted and described in respect of FIGS. 1 to 14 a user may engage a swipe functionality within a RSRAP in order to enter a single rating or multiple ratings. In order to trigger the RSRAP to capture the rating and/or display an indication of the user's swipe either in isolation or with reference to a mask/pattern etc. then the user performs one or more characteristic actions with respect to the touchscreen on their PED and/or FED. For example, the user may within embodiments of the invention hold a finger and/or thumb down in contact for a period of time that exceeds a predetermined threshold that is either globally set or set in respect of the context of the UI at that point in time. For example, within a web browser functions are normally short taps to select buttons etc. and hence a relatively short constant contact may be sufficient whereas within another application holding elements to move them may be an aspect of the application's operation and hence the contact time may be set longer than this. Within another embodiment of the invention the trigger may be a pattern of taps, e.g. left-right-left-right anywhere on the touchscreen or alternatively a swiping motion from, for example, left to right, bottom right diagonally upwards and left, etc.

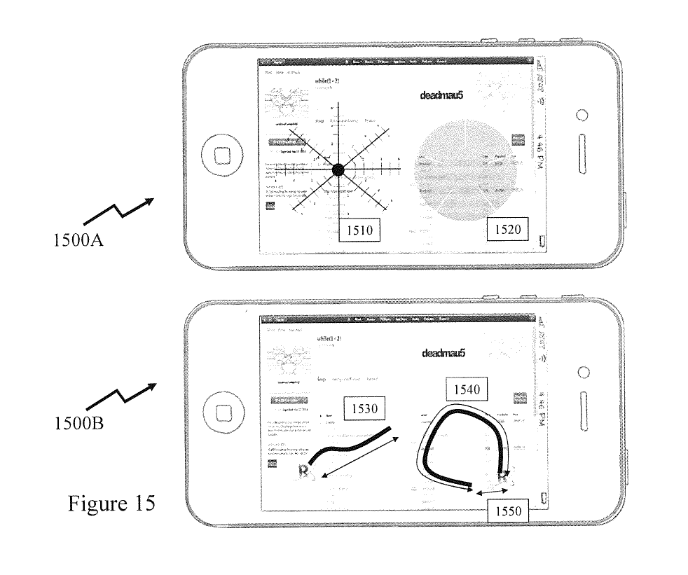

Referring to FIG. 15 there are depicted examples of calculating rating for a swipe performed by a user in respect of the new deadmau5 album “while(1<2)” with first and second images 1500A and 1500B respectively. In first image 1500A the user is presented with either first or second guide 1510 and 1520 respectively in respect of establishing a rating. In each instance the first or second guide 1510 and 1520 respectively may be disposed at a predetermined location on the screen or determined in dependence upon the location that the user triggers the RSRAP to receive rating input. In these examples the rating is merely dependent upon the distance of the end point from the centre of the first or second guide 1510 and 1520 respectively. Alternatively, text may be displayed around the periphery such as {Awful, Bad, Poor, Good, Very Good, Exceptional} wherein the rating is a combination of the sentiment in the segment the user swipes within and a value based upon how far they swipe within the first or second guide 1510 and 1520 respectively. In contrast within second image 1500B the rating is again determined by distance from the starting point with third guide 1530 and fifth guide 1550 respectively whereas for fourth guide 1540 the rating is calculated based upon the overall distance travelled rather than any direction aspect.

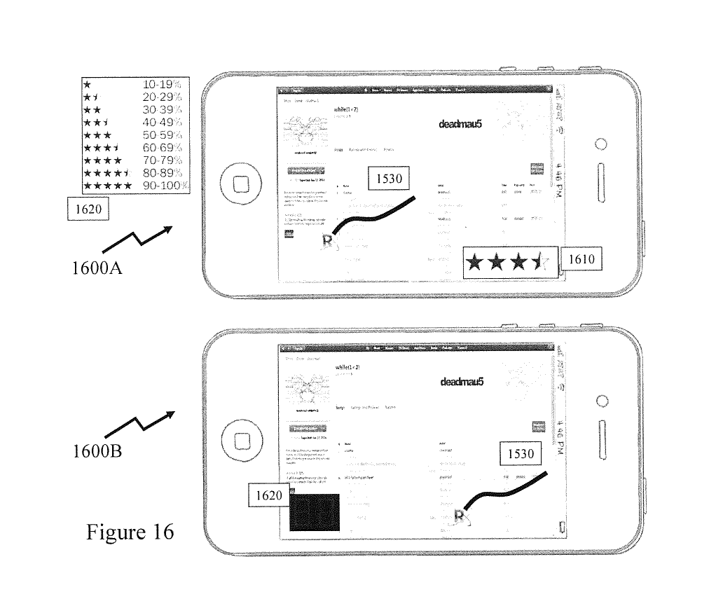

Referring to FIG. 16 there are depicted examples of calculating rating for a swipe performed by a user in respect of the new deadmau5 album “while(1<2)” with first and second images 1600A and 1600E respectively. In first image 1600A swipes the rating based distance from the starting point with third guide 1530 but now a display 1610 generates representation of how high a rating they give exploiting a series of stars wherein as indicated in chart 1620 three and a half stars corresponds to a rating of 60%-69%. In contrast in second image 1600B the user is presented with a display 1630 which generates representation of how high a rating they give a and hence can display.

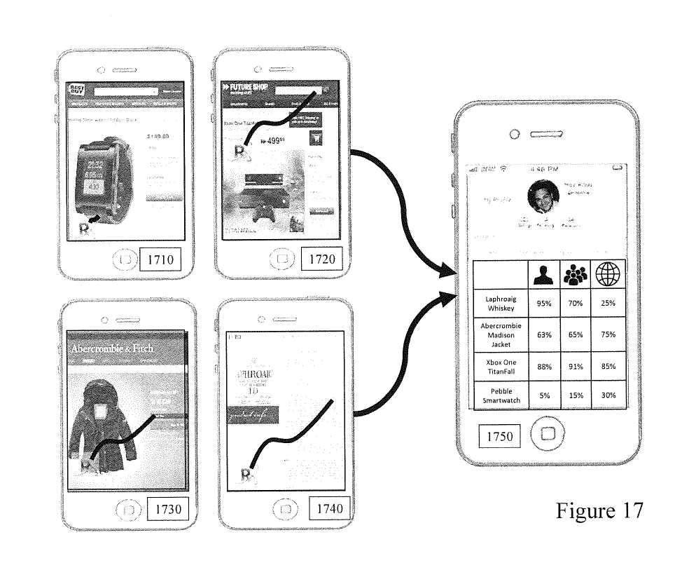

Now referring to FIG. 17 there are depicted first to fourth screenshots 1710 to 1740 relating to an overlay RSRAP on multiple websites and the aggregation to the user's profile as depicted in fifth screenshot 1750. Accordingly, in each of first to fourth screenshots 1710 to 1740 the user has been viewing content on their PED and has in execution a rating overlay application according to an embodiment of the invention. As such with each webpage they are viewing they are able to establish a rating through approaches described within this specification according to embodiments of the invention. Each rating they generate is stored within the RSRAP and associated with the user's profile as displayed in fifth screenshot 1750. Accordingly, the user is shown within their profile as having rated Laphroaig Whiskey, from their rating generated in fourth screenshot 1740; Abercrombie & Fitch Madison Jacket, from their rating generated in third screenshot 1730; Xbox One TitanFall console, from their rating generated in second screenshot 1720; and Pebble Smartwatch, from their rating generated in first screenshot 1710.

Optionally, for the user their entries within the profile may be hypertext links allowing the user to navigate to the content directly again. Optionally, the user may see the ratings for the same content from their friends and all users. In instances, such as Xbox One TitanFall console, for example, the ratings of their friends, all users, etc. may be based upon ratings of the product per se rather than ratings of FutureShop™ which is the content link for the user. Optionally, through multi-rating entry the user could rate factors such as price, product, and retailer or as depicted in FIG. 13 a provider providing content and aspects of the content itself. It would be evident that the user profile screen for the user may be configured by the user to display different elements and combinations of data.

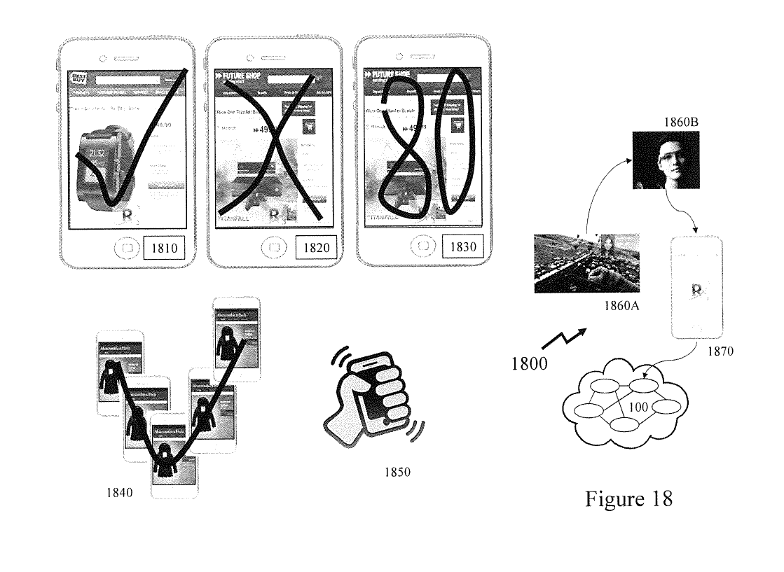

Now referring to FIG. 18 there are depicted haptic gesture based rating interfaces for a RSRAP according to embodiments of the invention. Within embodiments of the invention described supra in respect of FIGS. 1 through 17 the user has made a rating using a single swipe for one or more ratings based upon free swiping, guided swiping and scales. However, embodiments of the invention may exploit other entry formats for a rating such as depicted in first to fifth images 1810 to 1850 and architecture 1800. Within first to third images 1810 to 1830 respectively the user still exploits a touchscreen interface but now enters, for example, a tick gesture in first screenshot 1810, a cross gesture in second screenshot 1820, and sketches a number in third screenshot 1830. Optionally, the size of the tick or cross gestures may be used to scale the positive or negative response and the calculated factor is applied to an initial 50% rating. Alternatively, the faster the user makes the gesture the larger the magnitude such that a fast tick may be +40%, a fast cross −40%, a slow tick may be +15%, and a slow cross −15% so that the respective final ratings are 90%, 10%, 65%, and 35%.

Within fourth and fifth images 1840 and 1850 respectively a user may exploit the accelerometer within their PED to either trace a gesture, e.g. forming a virtual tick as shown in fourth image 1840 or shaking their PED as shown in fifth image 1850. In the latter instance the longer they shake or the harder they shake the larger the rating or if the RSRAP determines orientation of the PED as well then shaking with the PED “upright” can be increasing rating from 50%, for example, whilst shaking with the PED “upside down” can be decreasing the rating from 50%, for example. Alternatively, as depicted in architecture 1800 a user may have their PED 1870 coupled to a wearable device 1860B, e.g. Google Glass, which allows their gesture to be captured as part of generating a rating. Accordingly, the user may, for example, trigger a rating to be taken and the RSRAP on the PED 1870 processes the imagery from the wearable device 1860B generating the rating which is stored, for example, remotely on a server via network 100. Optionally, the user's PED may communicate with other wearable devices, such as wristbands, fitness meters, smart watches etc. and generate ratings based upon the user's actions such as those, for example, depicted in first to fifth images 1810 to 1850 respectively.

It would be evident that within embodiments of the invention the ratings may be generated by a user exploiting a PED either discretely or in combination with one or more wearable devices and/or one or more biometric sensors such that the rating, the content to which it is associated and the user's biometric information may be acquired as an associated data set. Accordingly, the user may within their profile view in association with ratings view their biometric data and/or be advised that there is a correlation. For example, a user's ratings within a period of time after they have completed their morning jog are lower/higher than those at other times. Hence, the user may when assessing/analyzing their quantified self be able to establish that certain physiological and/or psychological conditions are tending to lead their ratings and hence potentially decision making processes. Similarly, an advertiser may establish that a particular demographics' ratings, e.g. joggers/runners, for a particular product sector, e.g. athletics apparel, is higher within a 1-2 hour period after they have completed at least a 30 minute jog/run and accordingly may adjust the advertising provided to a user in association with their activities on their PEDs and/or FEDs when such conditions are established. Alternatively, analysis of user ratings for a particular product/enterprise etc. may be weighted according to biometric information such that a rating for a product is reduced/increased according to biometric data indicating the state of mental awareness of the user or that a rating of, for example, food and beverage items is weighted based upon an indication of the user's dietary state in respect of calories burnt versus absorbed as potentially a user may have higher ratings to any food/beverage item when hungry versus being more balanced in their rating having eaten/drunk within the past 30-60 minutes, for example.

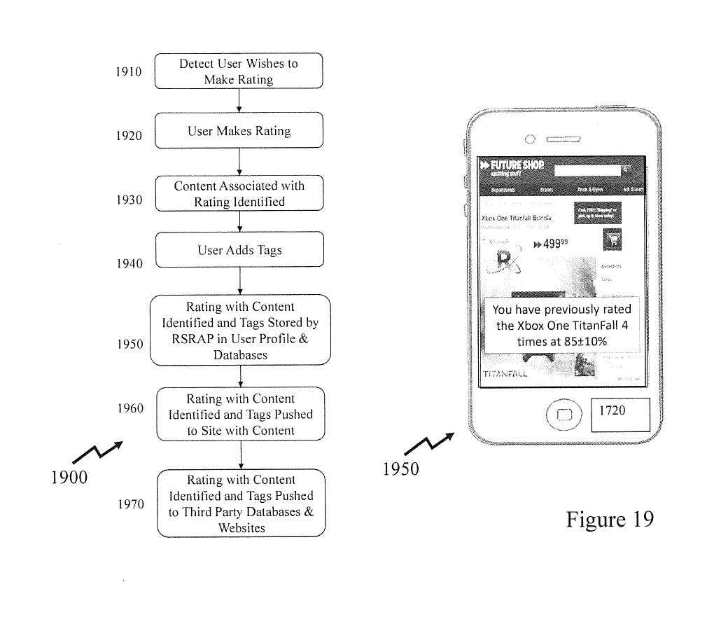

Referring to FIG. 19 there is depicted an exemplary flowchart 1900 for a rating acquisition and posting process according to an embodiment of the invention. The process is initiated at step 1910 wherein the RSRAP in execution upon a PED detects a predetermined action by the user as triggering a rating which is then generated in step 1920 by the user via a user action such as described supra in respect of embodiments of the invention. Once the rating has been generated the RSRAP acquires the content associated with the rating by parsing information relating to the current active screen, website, webpage, document, etc. in step 1930. Next in step 1940 the user may add hashtags to the rating such as described supra in respect of embodiments of the invention. Next in step 1950 the rating, content identity and hashtags (optionally) are stored by the RSRAP in association with the user's profile and other databases for use/access etc. Subsequently, in step 1960 the rating, content identity and hashtags are pushed to the website or other information resource associated with the content for which the content identity was established. Finally, in step 1970 the rating, content identity and hashtags are pushed to third party websites and/or databases. Such third party websites and/or databases may, for example, be associated with the original source of the content, e.g. the record company, news organization, enterprise, etc. or may be other information resources such as advertisers, search engines, SOCNETs, etc.

As the RSRAP maintains a user profile with previous ratings then as depicted in image 1950 in FIG. 19 where a user elects to make a rating, e.g. for the Xbox One TitanFall, then the RSRAP may retrieve information relating to the user's previous ratings indicating how many times they have previously rated the item of content, in this instance the Xbox One TitanFall, even if each rating was performed using a different source of content, e.g. WalMart™, Sears™, and Amazon™. It would also be evident that if the item of content was, for example, a video, cartoon, film, TV show, music that the user may make multiple ratings in association with the single item of content wherein these are all stored together with marker/timing information. The RSRAP may subsequently access one or more databases to establish content identities associated with markers/timing etc. Hence, the ratings of a user watching “Transformers—Revenge of the Fallen” may be associated with appearances of Megan Fox, for example. Alternatively, action sequences may have been rated. It would be evident that ratings may be generated and/or acquired in respect of live events, e.g. vote now for the next “American Idol”.

It would be evident to one skilled in the art that the embodiments of the invention with respect to the RSRAP provide for what the inventors refer to as a “rating layer” that sits as an additional layer within the technology/application stacks allow all data accessed by a user to be rated. This rating layer pushes the rated data to cloud servers to be processed wherein the original data and/or processed data are stored in association with the user's profile, the content, and other references/identifiers/databases etc. Accordingly, the content may include, but is not limited to, images, video, written content, audio, real time news events, current affairs, people, multimedia content, places, sports events, food, products, and concepts.

Within the embodiments of the invention the RSRAP allows a user's ratings irrespective of the platform/software/application etc. that they are generated upon to be centralized to the user's profile and, optionally, other profiles, databases, etc. A user can therefore rate on any technology/application stack and have the items and their ratings stored that they rate. The ratings can be kept private, shared with the user's SOCNET(s) and/or be public.

Optionally, a user may rate anonymously and may rate items anonymously wherein these ratings would also be stored relative to an anonymous profile of the user and whilst counting to analytics, public ratings etc. would not be included within the public profile of the user and/or the ratings visible to the user's SOCNET(s). Similarly, a user can rate with an alternate identity and can rate items using an alternate identity. The identity can be any character. These ratings would be stored relative to the users alternate identity profile

It would be apparent that a user may generate their own swipe shortcut to the RSRAP so that a gesture is associated with a rating shortcut. For example, a similar interface to that employed upon some devices to unlock them might be appropriate such that the user is presented with a template of nine dots and traces a gesture which is then subsequently matched with or without the template.

Embodiments of the invention allow a user to rate items of content and within the descriptions of embodiments of the invention and the specification these have been primarily considered as being content acquired by the user through their PED and/or FED from activities such as searching, browsing, viewing, etc. However, it would also be apparent that a user may themselves acquire content, e.g. photographs, video, etc. in respect of activities/events etc. that they are partaking in or are a spectator to. For example, in FIG. 18 the architecture 1800 considers the user as providing a haptic gesture in order to rate content acquired from a wearable device. This content may be an image, set of images, video, video segment, etc. acquired through a wearable device and pushed/posted to remote servers/applications via network 1800 including, but not limited to, RSRAP servers, SOCNET servers, etc. Optionally, such a process of acquiring, rating and pushing/posting content to the network/cloud may exploit content acquired directly by the PED discretely or in combination with one or more wearable devices.

It would also be evident that the rating of content may exploit non-haptic inputs generated by the user such as, for example, audio input wherein the user speaks a rating, e.g. two stars, eighty (meaning 80%), forty-five percent, etc. Optionally, the audio may be part of the content itself wherein, for example, user generated content is being analysed such that keyword searching of the audio is performed to establish user sentiments and derive a rating therefrom.

Embodiments of the invention allow trending content etc. to be aggregated prior to rating such that a rating is applied to the trending content subject rather than discrete trending items.

Embodiments of the invention allow for a user to exploit a search engine that provides search results that exploit the user's ratings, user's network ratings, and public ratings to filter, sort, display the search results.

Embodiments of the invention allow for advertisements and/or content to be associated with a user's rating feed wherein the advertisements and/or content are established in dependence upon what the user has searched/rated through the one swipe rating concepts and the user's rating of trending topics and content.

Accordingly, it would be evident that based upon the collation and aggregation of rating data relating to a user that a RSRP and/or another application may target content and/or advertising to the user based upon the ratings generated by a user and the items of content, data, information, enterprise reputation etc.

It would be evident that the RSRAP according to embodiments of the invention may be exploited within a portable/mobile environment.

It would be evident that the RSRAP according to embodiments of the invention may be exploited within a fixed electronic device, non-portable/non-mobile environments etc.

It would be evident to one skilled in the art that embodiments of the invention support a one-swipe rating generation mechanism wherein the user can swipe anywhere to rate any content, object, image, file, document, media element.

It would be evident to one skilled in the art that embodiments of the invention support a one-click rating generation mechanism wherein the user “clicks” once and then swipes upwards to generate a rating.

It would be evident that once rated embodiments of the invention allow for continuous, repeated sampling of a user, wherein the sampling rate or frequency may be determined by the user, the RSRAP, the content, advertiser, content host, etc.

Embodiments of the invention support the association of hashtags, trending keywords, user contextually derived keywords etc. with ratings made by the user.

It would be evident to one skilled in the art that embodiments of the invention support a method of generating a rating for an item through a single swipe/touch interaction by a user with a haptic interface.

It would be evident to one skilled in the art that embodiments of the invention support a method of generating a rating for an item through a single swipe/touch interaction by a user with a touchscreen interface.

It would be evident to one skilled in the art that embodiments of the invention support a method of generating a rating for an item through the acquisition and processing of information generated by at least one of a wearable device, a camera, and an accelerometer.

It would be evident to one skilled in the art that embodiments of the invention support a software application in execution upon an electronic device wherein the software application allows a user to enter a rating relating to content being viewed by the user associated with another software application in execution upon the electronic device.

It would be evident to one skilled in the art that embodiments of the invention support a method of establishing a rating profile associated with a rating application and a user by user interactions with a software application in execution upon an electronic device, wherein the rating profile aggregates ratings made by the user independent of the electronic device, the content being rated, and an application used to present the content to the user.

It would be evident to one skilled in the art that embodiments of the invention support a method according to claim 5, wherein the rating profile and rating application support at least one of allowing other users to follow the user, allowing the user to follow other users, aggregation of all ratings made by the user, and categorizing of the rating and/or content rated.

It would be evident to one skilled in the art that embodiments of the invention support a method of providing a rating feed to a user comprising aggregating ratings made by users in respect of content they have viewed independent of the electronic device, the content being rated, and an application used to present the content to the user.

It would be evident to one skilled in the art that embodiments of the invention support a method wherein the rating feed comprises a dynamic feed that allows the user to view at least one of the ratings the user makes, ratings of friends of the user within a social network, and all ratings made by other users.

It would be evident to one skilled in the art that embodiments of the invention support a method of rating content and/or aggregating ratings associated with at least one of an item of content and a location wherein the aggregation of ratings associated with the location is performed independent of the electronic devices and applications exploited by the users to view the content.

It would be evident to one skilled in the art that embodiments of the invention support a method of combining trending topics from a plurality of platforms upon which users generate ratings and/or hashtags.

It would be evident to one skilled in the art that embodiments of the invention support a method of accessing content by searching at least one of ratings associated with content and/or hashtags associated with the content in dependence upon at least a filter.

It would be evident to one skilled in the art that embodiments of the invention support a method wherein the filter is at least one of a predetermined threshold for the ratings, a filter limiting the results to those associated with the user profile of the user conducting the search, and a filter limiting the results to those associated with other users associated with the user within a social network.

It would be evident to one skilled in the art that embodiments of the invention support a method of accessing advertisements for display to a user by searching at least one of ratings associated with content and/or hashtags associated with the content in dependence upon at least a filter.

It would be evident to one skilled in the art that embodiments of the invention support a method of rating an item of content by applying a predetermined algorithm to a plurality of ratings, wherein each rating is associated with an aspect of the content.

It would be evident to one skilled in the art that embodiments of the invention support a method of generating a rating for a live item of content through a single swipe/touch interaction by a user with a haptic interface.

It would be evident to one skilled in the art that embodiments of the invention support a method wherein a plurality of ratings may be associated with the same live item of content by the user during the live event.

It would be evident to one skilled in the art that embodiments of the invention support a method of generating a plurality of ratings through a single continuous swipe/touch interaction by a user with a haptic interface.

It would be evident to one skilled in the art that embodiments of the invention support a method of establishing a rating by requesting through a software application in execution upon an electronic device a plurality of user ratings, wherein the plurality of user ratings are crowd sourced.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
generating a rating for an item by at least one of:
a single swipe or touch interaction by a user with a haptic interface, wherein the item is one of a plurality of items rated by the single swipe or touch interaction;
a single swipe or touch interaction by a user with a touchscreen interface, wherein the item is one of a plurality of items rated by the single swipe or touch interaction; and
the acquisition and processing of information generated by at least one of a wearable device, a camera, and an accelerometer.

2. The method according to claim 1, wherein
the rating is generated by applying a predetermined algorithm to a plurality of rating associated with the plurality of items generated by the single swipe or touch interaction.

3. The method according to claim 1, wherein
the rating relates to a live item of content presented to the user by an electronic device comprising the at least one of haptic interface, touch interface, camera, and accelerometer or the electronic device.

4. The method according to claim 1, wherein
the plurality of items are associated with an item of multimedia content presented to the user during a live event to which the item of multimedia content relates.

5. The method according to claim 1, wherein
the plurality of items relate to one of a same item and a plurality of items.

6. The method according to claim 1, wherein
the plurality of items are associated with an item of multimedia content presented to the user during a live event to which the item of multimedia content relates and the rating is acquired by a first software application whilst the item of multimedia content is presented with a second software application.

7. A method of establishing a rating profile associated with a rating application and a user by user interactions with a software application in execution upon an electronic device, wherein the rating profile aggregates ratings made by the user independent of the electronic device, the content being rated, and an application used to present the content to the user.

8. The method according to claim 7, wherein
the rating profile and rating application support at least one of:
allowing other users to follow the user;
allowing the user to follow other users;
aggregation of all ratings made by the user; and
categorizing of the rating and/or content rated.

9. The method according to claim 7, further comprising:
providing a rating feed to the user comprising aggregating ratings made by a plurality of users in respect of content they have viewed independent of the electronic device, the content being rated, and an application used to present the content to the plurality of users.

10. The method according to claim 4, wherein the rating feed comprises a dynamic feed that allows the user to view at least one of the ratings the user makes, ratings of friends of the user within a social network, and all ratings made by other users.

11. The method according to claim 7, wherein
the aggregated ratings are associated with at least one of an item of content and a location of the user.

12. The method according to claim 7, wherein
the rating profile establishes aggregrate ratings by combining trending topics from a plurality of software platforms or web services wherein which users generate ratings or hashtags relating to one or more of the topics.

13. The method according to claim 7, wherein
the rating profile allows a user to access content by searching at least one of ratings associated with content or hashtags associated with the content in dependence upon at least a filter.

14. The method according to claim 8, wherein
the filter is at least one of:
a predetermined threshold for the ratings;
a filter limiting the results to those associated with the user profile of the user conducting the search;
a filter limiting the results to those associated with other users associated with the user within a social network.

15. The method according to claim 7, wherein
the aggregate ratings relating to advertisements for display to a user.
